(19) United States
(12) Patent Application Publication
(10) Pub. No.: US 2012/0308785 A1
(43) Pub. Date: Dec. 6, 2012

(54) INKJET INK, INK CARTRIDGE, INKJET RECORDING APPARATUS, INKJET RECORDING METHOD, AND PRINT

(75) Inventor: Tomohiro NAKAGAWA, Kanagawa (JP)

(73) Assignee: RICOH COMPANY, LTD., Tokyo (JP)

(21) Appl. No.: 13/472,603

(22) Filed: May 16, 2012

(30) Foreign Application Priority Data
Jun. 2, 2011 (JP) 2011-123981

(51) Int. Cl. C09D 11/10; B41J 2/175; B32B 3/10

(52) U.S. Cl. 428/195.1; 524/561; 524/367; 347/86; 347/20

(57) ABSTRACT

An inkjet ink including an aqueous medium including water; and a water-soluble organic solvent; a resin-covered pigment which is dispersed in the aqueous medium and which is prepared by an acid deposition method; and a surfactant-treated pigment which is dispersed in the aqueous medium and which is prepared by treating a pigment with a nonionic surfactant. The inkjet ink has a pH in a range of from 8.5 to 10.5.

### CROSS-REFERENCE TO RELATED APPLICATIONS

This patent application is based on and claims priority pursuant to 35 U.S.C. §119 to Japanese Patent Application No. 2011-123981, filed on Jun. 2, 2011 in the Japan Patent Office, the entire disclosure of which is hereby incorporated herein by reference.

### TECHNICAL FIELD

This disclosure relates to an inkjet ink. In addition, this disclosure relates to an ink cartridge, an inkjet recording apparatus, and an inkjet recording method, which uses the inkjet ink. Further, this disclosure relates to a print prepared by using the inkjet ink.

### BACKGROUND

Inks using a dye have been broadly used for inks for inkjet printers. Since such dye inks have drawbacks such that images recorded by the inks have poor resistance to light and water, the dye inks have been replaced with pigment inks recently.

When a pigment is used as a colorant of an aqueous ink, it is necessary to stably disperse the pigment in an aqueous medium. Therefore, a dispersant such as surfactants and water soluble resins is generally used for dispersing a pigment in an aqueous medium to prepare a homogeneous pigment dispersion.

However, a pigment dispersion prepared by using a dispersant cannot be necessarily used for inkjet inks because of having insufficient pigment dispersing property. Therefore, several pigment dispersing methods have been proposed in attempting to prepare a pigment dispersion having good pigment dispersing property.

There are proposals for methods for preparing a resin-covered pigment such that a pigment is covered with an organic polymer compound having an anionic group using an acid deposition method. Such resin-covered pigments actually exist.

Although such resin-covered pigments have good properties, images recorded by using an ink using such a resin-covered pigment does not necessarily satisfy all of requirements such that images having a good combination of image quality (such as image density) and reliability can be formed on various kinds of recording materials.

In addition, according to recent demand for high speed inkjet recording, the level of requirements for an inkjet ink becomes higher and higher. Namely, a need exists for an inkjet ink which has a good combination of preservation stability and ejection reliability (i.e., an ability of being ejected from nozzles without any problems) and which can produce high quality images having high toughness. However, such an ink does not exist.

There is a proposal for an inkjet ink, which includes a resin-covered pigment prepared by using an acid deposition method, and a particulate polymer having a predetermined property, in attempting to impart a good combination of color development property, fixability, and ejection stability to the ink.

However, since the inkjet ink is intended to be used for textile, other image qualities such as image density and resistance of image to marker pens are not brought into focus. In addition, the ejection stability of the ink is described in the proposal, but the stability of the ink after a long period of preservation is not described therein. Therefore, the inkjet ink cannot fulfill such a requirement as to produce high quality images having high toughness while having a good combination of preservation stability and ejection reliability.

In addition, it is tried to prepare an ink by mixing two or more pigment dispersions having different dispersing states. For example, there are a proposal in which a self-dispersing type pigment and a pigment which is dispersed by a dispersant are used for an ink, and another proposal in which a self-dispersing type pigment and a resin-covered pigment are used for an ink. However, when different kinds of pigment dispersions, particularly pigment dispersions for which different dispersing methods are used, are mixed, the resultant pigment dispersion has only the drawbacks of the pigments with respect to dispersion stability without having the advantages of the pigment dispersions. Therefore, the different kinds of pigments are not stably dispersed in the resultant ink, and the resultant ink has poorer preservation stability than an ink prepared by using any one of the pigments.

In reality, color development property of the ink and toughness of ink images are described in the proposal, but the preservation stability of the ink is not described therein. Namely, the ink does not have good preservation stability.

Thus, there is no inkjet ink which has a good combination of preservation stability and ejection reliability and which can produce high quality images having high toughness.

For these reasons, the inventors recognized that there is a need for an inkjet ink which has a good combination of good preservation stability and ejection reliability and which can produce high quality images having high toughness.

### SUMMARY

As an aspect of this disclosure, an inkjet ink is provided which includes at least an aqueous medium including water and a water-soluble organic solvent; a resin-covered pigment which is dispersed in the aqueous medium and which is prepared by an acid deposition method; and a surfactant-treated pigment which is dispersed in the aqueous medium and which is prepared by treating a pigment with a nonionic surfactant. The inkjet ink has a pH in a range of from 8.5 to 10.5.

As another aspect of this disclosure, an ink cartridge is provided which includes a container, and the above-mentioned inkjet ink contained in the container.

As yet another aspect of this disclosure, an inkjet recording apparatus is provided which includes the ink cartridge mentioned above, and a recording head to eject droplets of the inkjet ink contained in the container of the ink cartridge to form an image on a recording material.

As a further aspect of this disclosure, an inkjet recording method is provided which includes ejecting the above-mentioned ink by applying a stimulus thereto to form an image on a recording material.

As a still further aspect of this disclosure, a print is provided which includes a support and an ink image formed on the support using the inkjet ink mentioned above.

The aforementioned and other aspects, features and advantages will become apparent upon consideration of the following description of the preferred embodiments taken in conjunction with the accompanying drawings.

### BRIEF DESCRIPTION OF THE SEVERAL VIEWS OF THE DRAWINGS

FIG. 1 is a schematic view illustrating an example of the ink cartridge of this disclosure;

FIG. 2 is a schematic view illustrating an example of the inkjet recording apparatus of this disclosure; and

FIG. 3 is a schematic view illustrating a recording head for use in the inkjet recording apparatus of this disclosure.

### DETAILED DESCRIPTION

Images prepared by so-called resin-covered pigments, in which a pigment is covered with an organic polymer compound having an ionic group, generally have a good combination of abrasion resistance and resistance to writing with a marker pen. Among resin-covered pigments, resin-covered pigments prepared by an acid deposition method have smaller particle diameters than resin-covered pigments prepared by other methods, and therefore inks prepared by using resin-covered pigments prepared by an acid deposition method have good ejection stability, and produce high definition images.

However, it is difficult to prevent releasing of the resin from the resin-covered pigments prepared by an acid deposition method, and in order to impart good preservation stability to the resultant ink, the pigment content of the ink has to be decreased.

In contrast, a pigment dispersed by a surfactant (hereinafter referred to as a surfactant-treated pigment) has a drawback in that the resultant images lack toughness, but has an advantage such that even when the pigment is used for the ink at a high concentration, few side effects are produced, and therefore images having a high image density can be easily produced.

Therefore, by using a combination of a resin-covered pigment and a surfactant-treated pigment, images having a high image density and toughness can be produced. However, resin-covered pigments prepared by an acid deposition method are easily agglomerated under acidic conditions, and therefore resin-covered pigments cannot be used in combination of pigments dispersed by a cationic surfactant. In addition, the resins of resin-covered pigments prepared by an acid deposition method are easily released therefrom under strong basic conditions. Therefore, when a resin-covered pigment prepared by an acid deposition method is used in combination with a pigment treated with an anionic surfactant, the resultant ink has extremely bad preservation stability. Therefore, resin-covered pigments cannot be used in combination of pigments dispersed by an anionic surfactant.

However, the present inventor discovers that by using a combination of a resin-covered pigment prepared by an acid deposition method and a nonionic surfactant-treated pigment while controlling the pH of the ink so as to fall in a range of from 8.5 to 10.5, the resultant ink has good preservation stability without causing the above-mentioned problems.

The reason why such an ink having good preservation stability can be prepared is not yet determined, but is considered to be as follows. Specifically, when the pH of the ink is in the above-mentioned range, releasing of the resin of the resin-covered pigment prepared by an acid deposition method is properly performed, and the released resin adsorbs on the nonionic surfactant-treated pigment, thereby stabilizing the ink.

The inkjet ink of this disclosure includes at least an aqueous medium including water and a water-soluble organic solvent; a resin-covered pigment prepared by an acid deposition method; and a nonionic surfactant-treated pigment while having a pH of from 8.5 to 10.5. The inkjet ink of this disclosure can optionally include other components such as a pH adjuster, a penetrant, an antiseptic agent, a fungicide, an antirust, etc.

The total content of pigments (including a resin-covered pigment and a nonionic surfactant-treated pigment) included in the inkjet ink is preferably from 0.1% by weight to 50.0% by weight, and more preferably from 0.1% by weight to 20.0% by weight, based on the total weight of the ink.

The weight ratio (A/B) of a resin-covered pigment (A) to a nonionic surfactant-treated pigment (B) is from 99/1 to 1/99, and preferably from 50/50 to 1/99 so that the resultant ink can produce the above-mentioned effects.

The pigments dispersed in the ink preferably have a 50% average particle diameter (D₅₀) of from 10 nm to 500 nm, and more preferably from 50 nm to 200 nm. The 50% average particle diameter (D₅₀) of pigments is measured under an environmental condition of 23° C. 55% RH using an instrument, MICROTRACK UPA from Nikkiso Co., Ltd., which uses a dynamic light scattering method.

Next, resin-covered pigments prepared by an acid deposition method for use in the inkjet ink of this disclosure will be described in detail.

Resin-covered pigments for use in the inkjet ink of this disclosure are defined as particulate materials in which a particulate pigment is included in a resin, i.e., particulate resins including a pigment therein. Dispersions of a resin-covered pigment for use in the inkjet ink of this disclosure includes at least a resin-covered pigment prepared by an acid deposition method, and water, and optionally includes other components such as a water-soluble resin, a surfactant, and an antiseptic agent.

Organic polymer compounds having an anionic group are preferably used as the resin of the resin-covered pigment. Any organic polymer compounds having an anionic group, which has a property such that when the anionic group of the polymer compounds is neutralized, the polymer compounds have a self-dispersing ability or a dissolving ability in water, can be used.

Specific examples of the anionic group of the organic polymer compounds include a carboxyl group, a sulfonic acid group, a phosphonic acid group, etc. Among these groups, a carboxyl group is preferable because polymer compounds having a carboxyl group have a good self-dispersing or a dissolving ability in water when being neutralized by a basic compound.

Organic polymer compounds having an anionic group preferably include an anionic group in an amount such that the acid value of the organic polymer compounds is from 30 mgKOH/g to 150 mgKOH/g, and preferably 50 mgKOH/g to 150 mgKOH/g. When the acid value of the polymer compound having an anionic group is greater than 150 mgKOH/g, the polymer compound has too high a hydrophilicity, and therefore the water resistance of the resultant ink images seriously deteriorates. In contrast, when the acid value of the polymer compound having an anionic group is less than 30 mgKOH/g, the polymer compound tends to have poor dispersibility in water (i.e., re-dispersibility) after being subjected to acid deposition, followed by neutralization, thereby deteriorating the dispersion stability of the pigment.

The polymer compounds of organic polymer compound having an anionic group for use in the inkjet ink of this disclosure is not particularly limited. Specific examples of the polymer compound include vinyl resins, polyester resins, amino resins, acrylic resins, epoxy resins, polyurethane resins, polyether resins, polyamide resins, unsaturated polyester resins, phenolic resins, silicone resins, fluorine-containing resins, combinations of these resins, etc.

Among these resins, acrylic resins are preferable. Among acrylic resins, acrylic resins having units obtained from (meth)acrylic acid, an alkyl ester thereof, and/or a hydroxyalkyl ester thereof, and optionally having a unit obtained from styrene. The total content of the acrylic units and the styrene unit in the acrylic resin is preferably not less than 80% by weight.

Acrylic resins having an anionic group for use in the inkjet ink of this disclosure are typically prepared by polymerizing an acrylic monomer having an anionic group, and other optional monomers, which can be copolymerized with the acrylic monomer, in a solvent. Specific examples of the acrylic monomer having an anionic group include acrylic monomers having one or more anionic groups selected from a carboxyl group, a sulfonic group, and a phosphonic group.

Among these monomers, acrylic monomers having a carboxyl group are preferable. In addition, a monomer having a group having a crosslinking ability can be used to improve the solvent resistance and durability of the resin cover of the resin-covered pigment (i.e., encapsulated pigment), and to enhance the abrasion resistance of the resultant ink images.

Specific examples of the acrylic monomers having a carboxyl group include acrylic acid, methacrylic acid, crotonic acid, ethacrylic acid, propylacrylic acid, isopropylacrylic acid, itaconic acid, fumaric acid, etc. Among these acids, acrylic acid and methacrylic acid are preferable.

Specific examples of the acrylic monomers having a sulfonic acid group include sulfoethyl methacrylte, butylacrylamidesulfonic acid, etc.

Specific examples of the acrylic monomers having a phosphonic acid group include phosphoethyl methacrylate, etc.

Specific examples of the monomers which can be copolymerized with acrylic monomers having an anionic group include (meth)acrylates such as methyl (meth)acrylate, ethyl (meth)acrylate, isopropyl (meth)acrylate, n-propyl (meth)acrylate, n-butyl (meth)acrylate, t-butyl (meth)acrylate, 2-ethylhexyl (meth)acrylate, n-octyl (meth)acrylate, laury (meth)acrylate, benzyl (meth)acrylate, isobutyl methacrylate, stearyl methacrylate, and tridecyl methacrylate; fatty acid adducts of (meth)acrylate monomers having an oxirane structure such as stearic acid adduct of glycidyl methacrylate; adducts of oxirane compounds having an alkyl group having 3 or more carbon atoms with (meth)acrylic acid; styrene monomers such as α-methylstyrene, o-methylstyrene, m-methylstyrene, p-methylstyrene, and p-t-butylstyrene; itaconates such as benzyl itaconate, and ethyl itaconate; maleates such as dimethyl maleate, and diethyl maleate; fumarates such as dimethyl fumarate, and diethyl fumarate; and other monomers such as (meth)acrylonitrile, vinyl acetate, isobornyl (meth)acrylate, aminoethyl (meth)acrylate, aminopropyl (meth)acrylate, methylaminoethyl (meth)acrylate, methylaminopropyl (meth)acrylate, ethylaminoethyl (meth)acrylate, ethylaminopropyl (meth)acrylate, aminoethylamide (meth)acrylate, aminopropylamide (meth)acrylate, methylaminoethylamide (meth)acrylate, methylaminopropylamide (meth)acrylate, ethylaminoethylamide (meth)acrylate, ethylaminopropylamide acrylate, methacrylamide, hydroxymethyl (meth)acrylate, 2-hydroxyethyl (meth)acrylate, 2-hydroxypropyl (meth)acrylate, N-methylolacrylamide, allylalcohol, etc.

Suitable monomers for use as the monomer having a crosslinking functional group include polymerizable monomers having a blocked isocyanate group, monomers having an epoxy group, monomers having a 1,3-dioxolane-2-one-4-yl group, etc.

Specific examples of the polymerizable monomers having a blocked isocyanate group include monomers obtained by adding a blocking agent to a polymerizable monomer having an isocyanate group such as 2-methacryloyloxyethyl isocyanate to perform an addition reaction. Alternatively, such monomers can be prepared by adding a compound having an isocyanate group and a blocked isocyanate group to a vinyl copolymer having a hydroxyl group and a carboxyl group to perform an addition reaction.

Compounds having an isocyanate group and a blocked isocyanate group can be easily prepared by mixing a diisocyanate compound and a known blocking agent in a molar ratio of 1/1 and performing an addition reaction.

Specific examples of the monomers having an epoxy group include glycidyl (meth)acrylate, (meth)acrylate monomers having an alicyclic epoxy group, etc.

Specific examples of the monomers having a 1,3-dioxolane-2-one-4-yl group include 1,3-dioxolane-2-one-4-ylmethyl (meth)acrylate, 1,3-dioxolane-2-one-4-ylmethyl vinyl ether, etc.

Specific examples of the polymerization initiator for use in polymerizing an acrylic monomer having an anionic group and an optional monomer, which can be copolymerized with the acrylic monomer, include peroxides such as t-butylperoxy benzoate, di-t-butyl peroxide, cumenperhydroxide, acetylperoxide, benzoyl peroxide, and lauroylperoxide; azo compounds such as azobisisobutyronitrile, azobis-2,4-dimethylvaleronitrile, and azobiscyclohexanecarbonitrile; etc.

Specific examples of the solvent for use in polymerizing an acrylic monomer having an anionic group and an optional monomer include aliphatic hydrocarbon solvents such as hexane, and mineral spirit; aromatic hydrocarbon solvents such as benzene, toluene, and xylene; ester solvents such as butyl acetate; ketone solvents such as methyl ethyl ketone, and methyl isobutyl ketone; alcoholic solvents such as methanol, ethanol, butanol, and isopropanol; polar aprotic solvents such as dimethylformamide, dimethyl sulfoxide, N-methylpyrrolidone, and pyridine; etc. These solvents can be used alone or in combination.

Next, the pigment for use in the inkjet ink of this disclosure will be described.

The pigment for use in the inkjet ink of this disclosure is not particularly limited, and any known inorganic and organic pigments can be used alone or in combination.

Specific examples of the inorganic pigments include titanium oxide, iron oxide, calcium carbonate, barium sulfate, aluminum hydroxide, barium yellow, ultramarine pigments, cadmium red, chrome yellow, metal powders, carbon blacks, etc. Among these pigments, carbon blacks are preferably used as black pigments. Specific examples of the carbon blacks include carbon blacks prepared by a known method such as contact methods, furnace methods, and thermal methods.

Suitable pigments for use as the organic pigments include azo pigments, azomethine pigments, polycyclic pigments, chelate dyes, nitro pigments, nitroso pigments, aniline black, etc. Among these pigments, azo pigments, and polycyclic pigments are preferable.

Specific examples of the azo pigments include azo lake pigments, insoluble azo pigments, condensed azo pigments, chelate azo pigments, etc.

Specific examples of the polycyclic pigments include phthalocyanine pigments, perylene pigments, perynone pigments, anthraquinone pigments, quinacridone pigments, dioxazine pigments, indigo pigments, thioindigo pigments, isoindolinone pigments, quinophthalone pigments, rohdamine B lake pigments, etc.

Specific examples of the chelate dyes include basic chelate dyes, acidic chelate dyes, etc.

Specific examples of black pigments for use in the black ink of this disclosure include carbon blacks (C.I. Pigment Black 7) such as furnace blacks, lamp blacks, acetylene blacks, and channel blacks; metals such as copper, iron (C.I. Pigment Black 11), and titanium oxide; organic pigments such as Aniline Black (C.I. Pigment Black 1); etc.

Among carbon blacks, carbon blacks, which are prepared by a furnace method or a channel method and which have an average primary particle diameter of from 15 nm to 40 nm, a BET specific surface area of from 50 m²/g to 300 m²/g, a DBP oil absorption of from 40 ml/100 g to 150 ml/100 g, a volatile material content of from 0.5% to 10% by weight, and a pH of from 2 to 9, are preferable.

Commercialized carbon blacks can be used as black pigments. Specific examples thereof include No. 2300, No. 900, MCF-88, No. 33, No. 40, No. 45, No. 52, MA7, MA8, MA100, and No. 2200B (from Mitsubishi Chemical Corp.); RAVENs 700, 5750, 5250, 5000, 3500, and 1255 (from Columbia Chemicals); REGALs 400R, 330R, and 660R, MOGUL L, and MONARCHs 700, 800, 880, 900, 1000, 1100, 1300, and 1400 (from Cabot Corp.); COLOR BLACKs FW1, FW2, FW2V, FW18, FW200, 5150, 5160, and 5170, PRINTEXs 35, U, V, 140U, and 140V, and SPECIAL BLACKs 6, 5, 4A, and 4 (from Degussa A.G.); etc.

Specific examples of yellow pigments for use in the yellow ink of this disclosure include C.I. Pigment Yellows 1, 2, 3, 12, 13, 14, 16, 17, 73, 74, 75, 83, 93, 95, 97, 98, 114, 120, 128, 129, 138, 150, 151, 154, 155, 174, and 180.

Specific examples of magenta pigments for use in the magenta ink of this disclosure include C.I. Pigment Reds 5, 7, 12, 48 (Ca), 48 (Mn), 57 (Ca), 57:1, 112, 122, 123, 146, 168, 176, 184, 185, and 202, and C.I. Pigment Violet 19.

Specific examples of cyan pigments for use in the cyan ink of this disclosure include C.I. Pigment Blues 1, 2, 3, 15, 15:3, 15:4, 15:34, 16, 22, 60, 63, and 66, and C.I. Vat Blues 4, and 60.

In addition, pigments newly developed for the inkjet ink of this disclosure can also be used.

Among these pigments, a combination of a yellow ink including Pigment Yellow 74, a magenta ink including Pigment Red 122 or Pigment Violet 19, and a cyan ink including Pigment Blue 15:3 is preferable because recorded full color images have a good combination of color tone and light resistance.

The resin-covered pigment included in the inkjet ink of this disclosure is typically prepared by an acid deposition method including the following processes.

(1) A process in which an organic polymer compound having an anionic group and a pigment are mixed or kneaded, and the mixture is dispersed in an alkaline aqueous medium;
(2) A process in which an acidic compound is added to the dispersion to control the pH of the dispersion so as to be not greater than 7 (neutral or acidic), so that the polymer is hydrophobized and deposited on the pigment;
(3) A process in which the resin-covered pigment dispersion is filtered, and the cake is washed with water, if desired; and
(4) A process in which a basic compound is added to the resin-covered pigment dispersion to neutralize part or all the anionic groups of the resin, thereby re-dispersing the pigment, i.e., forming an aqueous dispersion of the resin-covered pigment.

In the process (1), the following dispersing methods are preferably used.

(1-1) After a pigment and an organic polymer compound having an anionic group, which has been neutralized or has not been neutralized, are kneaded in an organic solvent, the mixture is dispersed in an aqueous medium.
(1-2) In an aqueous medium, a pigment and an organic polymer compound having an anionic group, which has been neutralized, are mixed or kneaded.

Specifically, in the method (1-1), a pigment, an organic polymer compound having an anionic group, and an organic solvent are subjected to a fine dispersing treatment using a known dispersing machine such as ball mills, sand mills, and colloid mills. In this regard, any known organic solvents can be used, but it is preferable to use solvents, which can dissolve well the resin used and which is not reactive with the resin used while having a higher vapor pressure than water so as to be easily removed after preparing the resin-covered pigment, and good compatibility with water.

Specific examples of such solvents include acetone, methyl ethyl ketone, methanol, ethanol, n-propanol, isopropanol, ethyl acetate, and tetrahydrofuran. In addition, methyl isopropyl ketone, methyl n-propyl ketone, isopropyl acetate, n-propyl acetate, methylene chloride, and benzene can also be used although the solvents have relatively low compatibility with water.

In order to disperse a dispersion, in which a pigment and an organic polymer compound having an anionic group are dispersed in an organic solvent, in an aqueous medium, the following methods can be used.

(I) The anionic group of the organic polymer compound is neutralized with a basic compound so that the polymer is hydrophilized, and the polymer is dispersed in water.
(II) The anionic group of the organic polymer compound dispersed in an organic solvent together with the pigment is neutralized using a basic compound, and the dispersion is dispersed in water.

In order to disperse an organic solvent dispersion of the polymer compound and the pigment, the following methods can be preferably used.

(a) After a basic compound is added to the organic solvent dispersion including a pigment and an organic polymer compound to neutralize the anionic group of the organic polymer compound, water is dropped into the dispersion.
(b) Water is dropped into a dispersion in which an organic polymer compound, whose anionic group is neutralized by a basic compound, and a pigment are dispersed in an organic solvent.
(c) Water including a basic compound is dropped into a dispersion in which an organic polymer compound having an anionic group, and a pigment are dispersed in an organic solvent.
(d) After a basic compound is added to the organic solvent dispersion including a pigment and an organic polymer compound to neutralize the anionic group of the organic polymer compound, the dispersion is added to an aqueous medium.
(e) A dispersion in which an organic polymer compound, whose anionic group has been neutralized by a basic compound, and a pigment are dispersed in an organic solvent is added to an aqueous medium.
(f) A dispersion in which an organic polymer compound having an anionic group, and a pigment are dispersed in an organic solvent is added to an aqueous medium including a basic compound.

When an organic solvent dispersion including a pigment and an organic polymer compound having an anionic group is dispersed in water or an aqueous medium, a dispersing method such as agitation using an agitator applying a low shear force, agitation using a dispersing machine applying a high shear force such as homogenizers, and dispersing using an ultrasonic dispersing machine can be used.

Specific examples of the basic compound for use in neutralizing the anionic group of an organic polymer compound include hydroxides of alkali metals such as sodium hydroxide, potassium hydroxide, and lithium hydroxide; organic amines such as ammonia, triethylamine, tributylamine, dimethylethanolamine, monoethanolamine, diethanolamine, triethanolamine, diisopropanolamine, and morpholine; etc.

In the above-mentioned method (1-2), initially an organic polymer compound having an anionic group is neutralized in an aqueous medium to be dissolved therein, and the solution is mixed or kneaded with a pigment in the aqueous medium. In this regard, the aqueous solution of the polymer compound can include an organic solvent. Alternatively, a solvent removing operation may be performed on the aqueous solution so that the aqueous medium consists essentially of only water.

The state of the pigment is not particularly limited, and pigment powders, aqueous pigment slurries, press cakes, and the like can be used.

When a pigment is dispersed in an aqueous medium, a pigment slurry or a press cake is preferably used because the amount of aggregated particles is small.

The kneading methods for kneading a pigment and an aqueous resin solution, the organic solvents, and the basic compounds, which are mentioned above for use in dispersing a pigment in an organic solvent, can also be used for this case.

In addition, when a pigment is kneaded with an aqueous resin solution or at a stage before the acid deposition process to be performed on the kneaded material, additives such as dyes, antioxidants, ultraviolet absorbents, crosslinking catalysts for the resin covering a pigment, antirusts, fragrance materials, and other chemicals can be added thereto.

The added amount of the organic polymer compound having an anionic group is preferably 25 parts to 200 parts by weight, and more preferably from 30 parts to 150 parts by weight, per 100 parts by weight of the pigment used. When the added amount is less than 25 parts by weight, it becomes hard to finely disperse the pigment in the polymer. In contrast, when the added amount is greater than 200 parts by weight, the content of the pigment in the resultant aqueous dispersion decreases. In this case, when the inkjet ink is prepared using the aqueous pigment dispersion, the added amount of the aqueous pigment dispersion has to be increased, resulting in deterioration of flexibility in formulation of the ink.

In the process (2) of the acid deposition method mentioned above, an organic polymer compound having an anionic group is fixedly adhered on a pigment, which is finely dispersed in an aqueous medium. Specifically, an acidic compound is added to the organic polymer compound, which has been neutralized by a basic compound, to control the pH so as not to be greater than 7 (i.e., neutral or acidic) so that the resin is hydrophobized.

Specific examples of the acid compound include inorganic acids such as hydrochloric acid, sulfuric acid, phosphoric acid, and nitric acid; organic acids such as formic acid, acetic acid, and propionic acid; etc. Among these acids, hydrochloric acid, and sulfuric acid are preferable because good acid deposition effects can be produced, and the amount of organic compounds included in waste water is small.

When the acid deposition treatment is performed, the pH of the pigment dispersion is preferably from 2 to 6. If a pigment, which is easily decomposed under highly acidic conditions, is used, the pH is preferably from 4 to 7.

It is preferable to remove the organic solvent in the pigment dispersion by a method such as reduced pressure distillation before the acid deposition treatment. After the acid deposition treatment, the pigment dispersion is filtered by a method such as suction filtration, pressure filtration, and centrifugal separation, and the resin-covered pigment is washed, if desired, to prepare an aqueous cake of the pigment.

In the process (4) of the acid deposition method mentioned above, the aqueous pigment cake, which is not dried, is subjected to a re-neutralization treatment using a basic compound to neutralize the anionic group of the polymer compound, so that the pigment particles are finely dispersed in the aqueous medium without being agglomerated.

In the re-neutralization treatment, it is sufficient to add a basic compound in an amount such that the pigment particles in the pigment cake can be loosened by the basic compound. However, the basic compound is added so that the pH of the cake becomes 7 or more, and preferably 7.5 or more.

When the aqueous pigment cake is dispersed again in water, a method, in which a basic compound is added to the pigment cake, and the mixture is agitated by an agitator such as stirrers, or a dispersing machine such as ultrasonic dispersing machines and NANOMIZER, can be used.

Suitable basic compounds for use in this re-neutralization treatment include metal hydroxides such as sodium hydroxide, potassium hydroxide, and lithium hydroxide; low-volatile organic amine compounds such as triethanolamine, and diethanolamine; and combinations of metal hydroxides and/or low-volatile organic amine compounds with volatile amines such as ammonia, triethylamine, and dimethylamine, so that the resultant inkjet ink has a good combination of re-dispesibility (or re-solubility, i.e., a property such that even when a part of the aqueous solvent is evaporated from the ink at inkjet nozzles, the ink can easily achieve the dispersion state again without causing any problems when a new ink is supplied from an ink cartridge) and durability.

Thus, by preparing a resin-covered pigment by the method mentioned above, small capsules, in which a pigment is encapsulated with a resin, can be prepared without using an emulsifier. Namely, a pigment encapsulated with a resin can be easily prepared.

The content of the pigment in the pigment covered with an anionic polymer compound is preferably from 35% by weight to 80% by weight. When the pigment content is less than 35% by weight, the content of the resin in the resin-covered pigment excessively increases, thereby often causing a problem in that the resin-covered pigment is not satisfactorily compatible with a resin, a solvent, and additives which are used for preparing an inkjet ink, and therefore the added amounts of such ink constituents have to be decreased or controlled in narrow ranges, resulting in deterioration of flexibility in formulation of the ink.

In addition, when the pigment content is low, recorded images have a low image density. In order to record high density images, the added amount of the resin-covered pigment has to be increased. In this case, problems such that the viscosity of the ink seriously increases, and/or preservation stability of the ink deteriorates tend to be caused.

When the pigment content is greater than 80% by weight, it becomes hard to finely disperse the pigment.

The anionic group of the anionic polymer compound covering a pigment is preferably present in a form of a salt with an alkali metal or an organic amine. It is preferable to use a hydroxide of an alkali metal such as sodium hydroxide, potassium hydroxide, and lithium hydroxide, because the inkjet ink has a good combination of re-dispersibility (re-solubility) and reliability. However, the water resistance of ink images slightly deteriorates because an inorganic salt group is present in the ink images.

Among organic amines, volatile amine compounds such as ammonia, triethylamine, tributylamine, diethanolamine, diisopropanolamine, and morphorine, and low-volatile amines such as diethanolamine, and triethanolamine are preferably used because good re-dispersibility (re-solubility) can be imparted to the resultant inkjet ink.

Next, the nonionic surfactant-treated pigment included in the inkjet ink of this disclosure will be described.

An aqueous dispersion of a nonionic surfactant-treated pigment, in which the pigment is dispersed in an aqueous medium, is used for preparing the inkjet ink of this disclosure.

The aqueous dispersion of a nonionic surfactant-treated pigment includes a pigment, a nonionic surfactant serving as a dispersant, and water, and optionally includes other components such as water-soluble resins, surfactants, and antiseptics.

In this disclosure, the nonionic surfactant-treated pigment means a pigment which is dispersed in an aqueous medium using a nonionic surfactant.

The pigment used for the nonionic surfactant-treated pigment is not particularly limited, and the pigments mentioned above for use in the resin-covered pigment can also be used.

Specific examples of the nonionic surfactant of the nonionic surfactant-treated pigment include polyoxyethylene alkylphenyl ethers, polyoxyethylene alkyl ethers, polyoxyethylene fatty acid esters, sorbitan fatty acid esters, polyoxyethylene sorbitan fatty acid esters, polyoxyethylene glycerin fatty acid esters, polyglycerin fatty acid esters, polyoxyethylene sorbit fatty acid esters, polyoxyethylene sterol, polyoxyethylene polyoxypropylene alkyl ethers, polyoxyethylene fatty acid amides, polyoxyethylene polyoxypropylene block copolymers, tetramethyl decyne diol, ethylene oxide adducts of tetramethyl decyne diol, etc. These surfactants can be used alone or in combination.

Among these nonionic surfactants, nonionic surfactants having a polyoxyethylene group as a hydrophilic group are preferable because charges on the surface of the pigment can be properly maintained, and foaming of the ink can be suppressed.

Among the nonionic surfactants, compounds having the following formula (I) are more preferable.

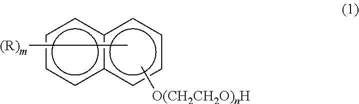

wherein R represents an alkyl group having 1 to 20 carbon atoms, an aryl group, or an aralkyl group, m is 0 or an integer of from 1 to 7, and n is an integer of from 20 to 200.

By using a nonionic surfactant having formula (I), an inkjet ink in which a pigment is dispersed while having a small particle diameter and a narrow standard deviation of particle diameter can be prepared.

The inkjet ink of this disclosure includes a pH controlling agent to control the pH of the ink in a range of from 8.5 to 10.5.

When the pH is lower than 8.5, the resin of the resin-covered pigment prepared by an acid deposition method is hardly released therefrom, and thereby the surfactant-treated pigment is not satisfactorily stabilized in the ink. In contrast, when the pH is higher than 10.5, the resin is excessively released from the resin-covered pigment, thereby deteriorating the preservation stability of the ink.

The pH of the inkjet ink is controlled by adding a pH controlling agent in an amount such that the ink has the targeted pH.

Any known pH controlling agents can be used as long as the pH of the ink can be controlled thereby in the above-mentioned range. Specific examples of the pH controlling agent include amines such as diethanolamine, and triethanolamine; hydroxides of quaternary ammonium such as decyltrimethylammonium hydroxide, and tetrabutylammonium hydroxide; hydroxides of alkali metals such as lithium hydroxide, and sodium hydroxide; etc. Among these pH controlling agents, amines are preferable because of hardly affecting the dispersing property of the pigments in the ink.

The inkjet ink of this disclosure includes a water-soluble organic solvent to produce a moisturizing effect, thereby imparting good ejection stability to the ink.

The content of a water-soluble organic solvent in the ink is preferably from 10% to 50% by weight, and more preferably from 20% to 40% by weight. When the content falls in this range, occurrence of a problem in that when water is evaporated from the ink in an inkjet recording apparatus, the viscosity of the ink seriously increases, resulting in defective ejection of droplets of the ink can be prevented. In addition, when droplets of the ink are adhered to a recording material to form an image, water in the ink image is rapidly evaporated, thereby increasing the viscosity of the ink forming the image, resulting in prevention of formation of a blurred image (i.e., formation of a high quality image).

When the content of a water-soluble organic solvent in the ink is less than 10% by weight, water in the ink is easily evaporated, and a nozzle clogging problem in that inkjet nozzles are clogged with the viscous ink tends to be caused. In contrast, when the content is greater than 50% by weight, it is often necessary to decrease the added amounts of a pigment and a resin, thereby forming ink images with a low image density. When the content is greater than 50% by weight, the nozzle clogging problem due to increase of the viscosity of the ink is hardly caused. However, when the ink is adhered to a recording material to form an ink image, the viscosity of the ink image is not rapidly increased, thereby causing a bleeding problem in that the ink bleeds on a recording material.

Specific examples of the water-soluble organic solvent included in the inkjet ink of this disclosure include, but are not limited thereto, polyalcohols such as ethylene glycol, diethylene glycol, triethylene glycol, polyethylene glycol, polypropylene glycol, 1,3-butanediol, 3-methyl-1,3-butanediol, 1,5-pentanediol, 2,2,4-trimethyl-1,3-pentanediol, 1,6-hexanediol, glycerin, 1,2,6-hexanetriol, 2-ethyl-1,3-hexanediol, 1,2,3-butanetriol, 1,2,4-butanetriol, and petriol; polyalcohol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyalcohol aryl ethers such as ethylene glycol monophenyl ether, and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethylimidazolidinone, ε-caprolactam, and γ-butyrolactone; amides such as formamide, N-methylformamide, and N,N-dimethylformamide; amines such as monoethanolamine, diethanolamine, and triethylamine; sulfur-containing compounds such as dimethylsulfoxide, sulfolane, and thiodiethanol; other solvents such as propylene carbonate, and ethylene carbonate; etc. These water-soluble organic solvents can be used alone or in combination.

Among these water-soluble organic solvents, 1,3-butanediol, diethylene glycol, triethylene glycol, and glycerin are preferable because of effectively preventing drying of the ink due to evaporation of water in the ink, thereby preventing occurrence of the nozzle clogging problem (i.e., preventing deterioration of ejection property of the ink).

Next, the method for preparing the inkjet ink of this disclosure will be described. The inkjet ink of this disclosure can be prepared by any known inkjet ink preparation methods. For example, a method including the following processes can be used.

(1) Ink components including at least water, a water-soluble organic solvent, a dispersion of a surfactant-treated pigment, and a dispersion of a resin-covered pigment are mixed while agitated;
(2) The pH of the mixture is adjusted;
(3) The pH controlled mixture was subjected to filtration such as filtration under reduced pressure, pressure filtration, and centrifugal filtration using a centrifugal separator, which use a filter such as metal filters and membrane filters, to remove coarse particles and foreign materials; and
(4) The filtered mixture is deaerated if necessary, resulting in preparation of an inkjet ink.

The inkjet ink of this disclosure can optionally include other components such as penetrants, dispersants, stabilizers, defoaming agents, antiseptics, fungicides, antirusts, antioxidants, etc. Any known materials of these components can be used for the inkjet ink of this disclosure.

Next, the ink cartridge of this disclosure will be described. The ink cartridge of this disclosure has a container in which the inkjet ink of this disclosure is contained, and optionally has other members if necessary. The shape, structure, size, and constitutional material of the container are not particularly limited. For example, aluminum laminated film bags, and ink bags made of a resin film can be preferably used as the container. In addition, a container, which can be detachably attached to the inkjet recording apparatus mentioned later, can be more preferably used.

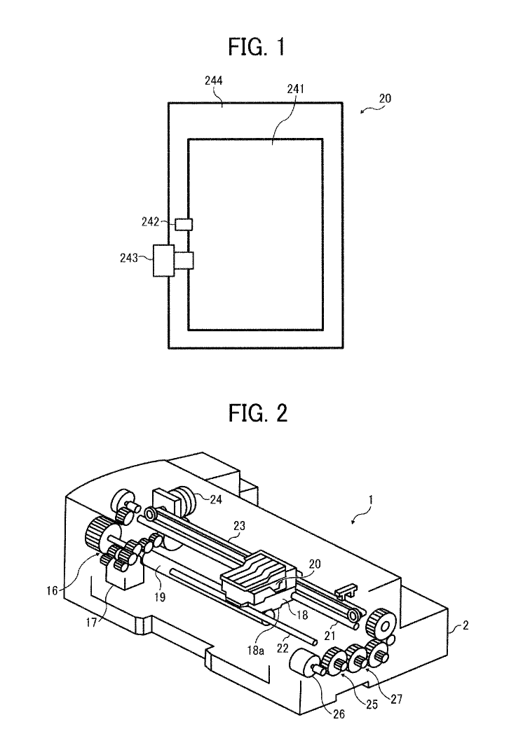

FIG. 1 is a schematic view illustrating an example of the ink cartridge of this disclosure. Referring to FIG. 1, an ink cartridge 20 includes an ink bag 241 serving as a container, an ink inlet 242 from which an ink, which is the inkjet ink of this disclosure, is fed to the ink bag, an ink outlet 243 from which the ink is discharged, and a cartridge case 244. After the ink is fed into the ink bag 241, air is discharged from the ink bag 241, and the ink inlet 242 is closed by welding or the like. When the ink cartridge 20 is used, the ink bag 241 is set in an inkjet recording apparatus so that a needle of the inkjet recording apparatus is inserted into the ink outlet 243 of the ink bag 241. The ink bag 241 is contained in the cartridge case 244 typically made of a plastic. The resultant ink cartridge 20 is typically used by being detachably attached to various inkjet recording apparatuses.

Next, the inkjet recording method and apparatus of this disclosure will be described.

The inkjet recording method of this disclosure includes at least a step of ejecting droplets of the inkjet ink of this disclosure, and optionally includes other steps such as a stimulus generating step of generating a stimulus to be applied to the ink, and a controlling step of controlling ejection of ink droplets. The inkjet recording apparatus of this disclosure includes at least a recording head to eject droplets of the inkjet ink of this disclosure, and optionally includes other devices such as a stimulus generator to generate a stimulus to be applied to the ink, and a controller to control ejection of ink droplets. The inkjet recording method of this disclosure can be preferably performed by the inkjet recording apparatus of this disclosure, and the ink ejecting step can be preferably performed by the recording head. The optional stimulus generating step and controlling step can be preferably performed by a stimulus generator and a controller, respectively.

In the ink ejecting step, a stimulus (i.e., energy) is applied to the inkjet ink of this disclosure to eject the ink toward a recording material to form an image on the recording material. The recording head applies a stimulus (energy) to the inkjet ink of this disclosure to eject the ink toward a recording material to form an image on the recording material. The recording head is not particularly limited, and, for example, inkjet nozzles, etc., can be used therefor.

The ink cartridge and the inkjet recording apparatus of this disclosure will be described by reference to FIGS. 1-3. FIG. 2 illustrates an inkjet recording apparatus 1 as an example of the inkjet recording apparatus of this disclosure.

In the inkjet recording apparatus 1 illustrated in FIG. 2, plural ink cartridges 20 each containing a color ink, which is the inkjet ink of this disclosure, are set in a carriage 18. Although plural ink cartridges are set in the carriage 18 in FIG. 1, the number of the ink cartridges is not particularly limited, and one or more ink cartridges are set in the carriage 18. The inks in the ink cartridges 20 are supplied to a recording head (droplet ejection head) 18a, which is set in the carriage 18 and which ejects droplets of the color inks downward from the recording head 18a.

The recording head 18a set in the carriage 18 is moved in a main scanning direction by a timing belt 23, which is driven to rotate by a main scanning motor 24 while guided by guide shafts 21 and 22. Meanwhile, a recording material such as coated papers, on which an ink image is to be formed, is fed toward a platen 19 by a motor 26 via gear mechanisms 25 and 27. The recording material is fed in a sub-scanning direction by the platen 19, which is rotated by a sub-scanning motor 17 via a gear mechanism 16, while facing the recording head 18a.

Since the recording head 18a ejects droplets of the color inks toward a portion of the recording material on the platen 19 while moving in the main scanning direction, a strip-shaped color image is formed on the recording material. After the recording material is fed in a predetermined length in the sub-scanning direction perpendicular to the main scanning direction by the sub-scanning motor 17 and the gear mechanism 16, the image forming operation mentioned above is performed again to form another strip-shaped color image on the recording material. By repeating this image forming operation while feeding the recording material in the sub-scanning direction, a full color image is formed on the recording material. In FIG. 2, numeral 2 denotes a main body of the inkjet recording apparatus 1.

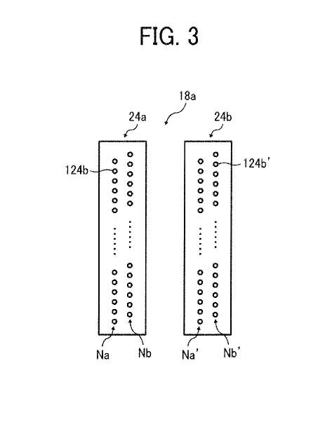

One example of the recording head is illustrated in FIG. 3. As illustrated in FIG. 3, a recording head 18a include a first ink ejecting head 24a and a second ink ejecting head 24b. The first ink ejecting head 24a has a line nozzle 124b including lines of nozzles Na and Nb to eject yellow (Y) ink droplets and magenta (M) ink droplets, respectively, and the second ink ejecting head 24b has anther line nozzle 124b′ including lines of nozzles Na′ and Nb′ to eject cyan (C) ink droplets and black (K) ink droplets, respectively.

Specific examples of the first and second liquid ejecting heads 24a and 24b include piezoelectric actuators using a piezoelectric element, thermal actuators utilizing phase change (evaporation) of a liquid film performed by using an electricity-heat conversion element such as resistors, shape-memory-alloy actuators utilizing phase change of a metal caused by temperature change, and electrostatic actuators utilizing electrostatic force.

The inkjet recording apparatus of this disclosure is an inkjet recording apparatus having a continuous ejection type recoding head or an on-demand type recording head. Specific examples of such on-demand type recording head include piezoelectric inkjet recoding heads, thermal inkjet recording heads, and electrostatic inkjet recording heads.

Known techniques such as the techniques described in a published unexamined Japanese patent application No. 2000-198958, incorporated herein by reference, can be properly applied to the ink cartridge, the inkjet recording apparatus and the inkjet recording method of this disclosure.

The print of this disclosure is a print formed by the inkjet recording apparatus and the inkjet recording method of this disclosure. The print of this disclosure includes a support (recording material) and an ink image formed on the support using the inkjet ink of this disclosure mentioned above. The support is not particularly limited, and for example, plain papers, glossy papers, special papers, cloths, films, OHP (overhead projection) sheets, general-purpose print papers, etc., can be used therefor. These supports can be used alone or in combination. Since the print of this disclosure has a good combination of image quality, and preservation stability, the print can be preferably used as documents for archival purpose.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### (Preparation of Resin-Covered Pigment Dispersion)

### 1. Black Pigment Dispersion A

### (1) Synthesis of Solution (A-1) of Anionic Group Containing Organic Polymer Compound

Initially, 1,000 parts of methyl ethyl ketone was fed into a 3-litter four-necked flask equipped with a dropping funnel, a thermometer, a nitrogen feed pipe, an agitator, and a reflux condenser, and then heated to 78° C. A mixture of 700 parts of n-butyl methacrylate, 42 parts of n-butyl acrylate, 150 parts of 2-hydroxyethyl methacrylate, 108 parts of methacrylic acid, and 80 parts of t-butylperoxy-2-ethylhexanoate was dropped from the dropping funnel to the flask over 4 hours, followed by heating the mixture for 8 hours at the temperature to perform a polymerization reaction.

After the reaction product was cooled to room temperature, methyl ethyl ketone was added thereto to adjust the content of non-volatile components of the reaction product to 50% by weight. Thus, a solution A-1 of an organic polymer compound having an anionic group (hereinafter referred to as a resin solution A-1) was prepared.

### (2) Preparation of Resin-Covered Pigment Dispersion Using Acid Deposition Method

### (2-1) Pigment Kneading Process

The following components were fed into a 250 ml glass container.

| | |
|---|---|
| The resin solution A-1 prepared above | 15.0 parts |
| Dimethylethanolamine | 0.8 parts |
| Carbon black | 15 parts |
| (NIPEX-IQ from Degussa A.G.) | |
| Ion exchange water | 44.2 parts |

Next, 250 g of zirconia beads having an average particle diameter of 0.5 mm were fed into the glass container and the mixture was kneaded for 4 hours using a paint shaker. By removing the zirconia beads therefrom, an aqueous dispersion including the pigment (carbon black) and a resin whose carboxyl group was neutralized by the basic compound (dimethylethanolamine) was prepared.

### (2-2) Acid Deposition Process

The aqueous dispersion prepared above was diluted with an equal amount of ion exchange water. Next, a 1N hydrochloric acid was added to the diluted aqueous dispersion while agitating the mixture with a disperser until the resin became insoluble and deposited on the pigment. In this case, the pH of the mixture was 3 to 5.

### (2-3) Filtration and Washing Process

After the aqueous dispersion including the pigment on which the resin is fixed was subjected to a suction filtration treatment, the resultant cake was washed with water to prepare a wet cake.

### (2-4) Neutralization and Re-Dispersing Process

A 10% aqueous solution of sodium hydroxide was added to the wet cake until the mixture has a pH of from 8.5 to 9.5. After the mixture was agitated for 1 hour, ion exchange water was added thereto to adjust the pigment concentration to 15%. Thus, a black pigment dispersion A was prepared.

### 2. Cyan Pigment Dispersion A

The procedure for preparation of the black pigment dispersion A was repeated except that the carbon black was replaced with Pigment Blue 15:3 to prepare a cyan pigment dispersion A.

### 3. Magenta Pigment Dispersion A

The procedure for preparation of the black pigment dispersion A was repeated except that the carbon black was replaced with Pigment Red 122 to prepare a magenta pigment dispersion A.

### 4. Yellow Pigment Dispersion A

The procedure for preparation of the black pigment dispersion A was repeated except that the carbon black was replaced with Pigment Yellow 74 to prepare a yellow pigment dispersion A.

### 5. Black Pigment Dispersion B

The procedure for preparation of the black pigment dispersion A was repeated except that the resin solution A-1 was replaced with the following resin solution B-1 to prepare a black pigment dispersion B.

(1) Synthesis of solution (B-1) of anionic group containing organic polymer compound

Initially, the following components were fed into a 2-litter four-necked flask equipped with a dewatering conduit, a thermometer, a nitrogen feed pipe, and an agitator.

| | |
|---|---|
| Glycidyl ester of synthetic fatty acid | 100 parts |
| (CARDURA E-10 from Shell Chemicals) | |
| Adipic acid | 241 parts |
| Hexahydrophthalic anhydride | 376 parts |
| Neopentyl glycol | 195 parts |
| Trimethylolpropane | 165 parts |
| Dibutyltin oxide | 0.5 parts |

The mixture was heated to 190° C. over 5 hours while removing water therefrom, followed by a dehydration condensation reaction at the temperature. The dehydration condensation reaction was performed while measuring the acid value of the reaction product, and the reaction was stopped when the acid value became the targeted acid value (60 mgKOH/g). After the reaction product was cooled, methyl ethyl ketone was added thereto to adjust the content of non-volatile components of the reaction product to 65% by weight. Thus, a solution B-1 of an organic polymer compound having an anionic group (resin solution B-1), which has an acid value of 61 mgKOH/g, was prepared.

### 6. Cyan Pigment Dispersion B

The procedure for preparation of the black pigment dispersion B was repeated except that the carbon black was replaced with Pigment Blue 15:3 to prepare a cyan pigment dispersion B.

### 7. Magenta Pigment Dispersion B

The procedure for preparation of the black pigment dispersion B was repeated except that the carbon black was replaced with Pigment Red 122 to prepare a magenta pigment dispersion B.

### 8. Yellow Pigment Dispersion B

The procedure for preparation of the black pigment dispersion B was repeated except that the carbon black was replaced with Pigment Yellow 74 to prepare a yellow pigment dispersion B.

### 9. Black Pigment Dispersion C

A resin-covered pigment dispersion was prepared by a phase transition emulsification method. Specifically, the following components were mixed and agitated.

| | |
|---|---|
| The resin solution A-1 prepared above | 28 parts |
| Carbon black | 26 parts |
| (NIPEX 150-IQ from Degussa A.G.) | |
| 1 mole/L Aqueous solution of potassium hydroxide | 13.6 parts |
| Methyl ethyl ketone | 20 parts |
| Ion exchange water | 30 parts |

The mixture was kneaded by a three roll mill.

The kneaded mixture (paste) was mixed with 200 parts of ion exchange water, and the mixture was agitated well. After methyl ethyl ketone was distilled away using an evaporator (in this case, a small portion of water was also distilled away), the residue was filtered using an acetyl cellulose filter having openings of 5 μm to remove coarse particles therefrom. Thus, a black pigment dispersion C was prepared.

### 10. Cyan Pigment Dispersion C

The procedure for preparation of the black pigment dispersion C was repeated except that the carbon black was replaced with Pigment Blue 15:3 to prepare a cyan pigment dispersion C.

### 11. Magenta Pigment Dispersion C

The procedure for preparation of the black pigment dispersion C was repeated except that the carbon black was replaced with Pigment Red 122 to prepare a magenta pigment dispersion C.

### 12. Yellow Pigment Dispersion C

The procedure for preparation of the black pigment dispersion C was repeated except that the carbon black was replaced with Pigment Yellow 74 to prepare a yellow pigment dispersion C.

### (Preparation of Surfactant-Treated Pigment Dispersion)

### 13. Black Pigment Dispersion D

The following components were mixed.

| | |
|---|---|
| Carbon black | 200 parts |
| (NIPEX 150-IQ from Degussa A.G.) | |
| Polyoxyethylene(n = 40) β-naphtyl ether | 50 parts |
| (i.e., a compound having formula (1) wherein m is 0, | |
| and n is 40) | |
| Distilled water | 750 parts |

The mixture was subjected to a dispersing treatment using a bead mill (UAM-015 from Kotobuki Industries Co., Ltd. The dispersing conditions were as follows.

Dispersing media: Zirconia beads having a diameter of 0.03 mm

Rotation speed of agitator: 10 m/s

Dispersing temperature: 30° C.

Dispersing time: 15 minutes

The resultant dispersion was subjected to a centrifugal separation treatment using a centrifugal separator (MODEL-3600 from Kubota Corp.) to remove coarse particles therefrom. Thus, a black pigment dispersion D was prepared.

### 14. Cyan Pigment Dispersion D

The procedure for preparation of the black pigment dispersion D was repeated except that the carbon black was replaced with Pigment Blue 15:3 to prepare a cyan pigment dispersion D.

### 15. Magenta Pigment Dispersion D

The procedure for preparation of the black pigment dispersion D was repeated except that the carbon black was replaced with Pigment Red 122 to prepare a magenta pigment dispersion D.

### 16. Yellow Pigment Dispersion D

The procedure for preparation of the black pigment dispersion D was repeated except that the carbon black was replaced with Pigment Yellow 74 to prepare a yellow pigment dispersion D.

### 17. Black Pigment Dispersion E

The procedure for preparation of the black pigment dispersion D was repeated except that the surfactant was replaced with polyoxyethylene(n=25) octyl dodecyl ether, which is a nonionic surfactant having a polyoxyethylene group as a hydrophilic group, to prepare a black pigment dispersion E.

### 18. Cyan Pigment Dispersion E

The procedure for preparation of the black pigment dispersion E was repeated except that the carbon black was replaced with Pigment Blue 15:3 to prepare a cyan pigment dispersion E.

### 19. Magenta Pigment Dispersion E

The procedure for preparation of the black pigment dispersion E was repeated except that the carbon black was replaced with Pigment Red 122 to prepare a magenta pigment dispersion E.

### 20. Yellow Pigment Dispersion E

The procedure for preparation of the black pigment dispersion E was repeated except that the carbon black was replaced with Pigment Yellow 74 to prepare a yellow pigment dispersion E.

### 21. Black Pigment Dispersion F

The procedure for preparation of the black pigment dispersion D was repeated except that the surfactant was replaced with decaglycerin monolaurate, which is a nonionic surfactant having no polyoxyethylene group as a hydrophilic group, to prepare a black pigment dispersion F.

### 22. Cyan Pigment Dispersion F

The procedure for preparation of the black pigment dispersion F was repeated except that the carbon black was replaced with Pigment Blue 15:3 to prepare a cyan pigment dispersion F.

### 23. Magenta Pigment Dispersion F

The procedure for preparation of the black pigment dispersion F was repeated except that the carbon black was replaced with Pigment Red 122 to prepare a magenta pigment dispersion F.

### 24. Yellow Pigment Dispersion F

The procedure for preparation of the black pigment dispersion F was repeated except that the carbon black was replaced with Pigment Yellow 74 to prepare a yellow pigment dispersion F.

### 25. Black Pigment Dispersion G

The procedure for preparation of the black pigment dispersion D was repeated except that the surfactant was replaced with polyoxyethylene(n=12)decanoic acid sodium salt, which is an anionic surfactant, to prepare a black pigment dispersion G.

### 26. Cyan Pigment Dispersion G

The procedure for preparation of the black pigment dispersion G was repeated except that the carbon black was replaced with Pigment Blue 15:3 to prepare a cyan pigment dispersion G.

### 27. Magenta Pigment Dispersion G

The procedure for preparation of the black pigment dispersion G was repeated except that the carbon black was replaced with Pigment Red 122 to prepare a magenta pigment dispersion G.

### 28. Yellow Pigment Dispersion G

The procedure for preparation of the black pigment dispersion G was repeated except that the carbon black was replaced with Pigment Yellow 74 to prepare a yellow pigment dispersion G.

### (Preparation of Inks)

### Example 1

The following components were mixed and agitated for 90 minutes, followed by filtering using a membrane filter having openings of 0.8 μm to prepare a black ink.

| | |
|---|---|
| Black pigment dispersion A | 3.0 parts |
| (resin-covered pigment dispersion) | |
| Black pigment dispersion D | 5.0 parts |
| (surfactant-treated pigment dispersion) | |
| Glycerin | 15.0 parts |
| (water-soluble organic solvent) | |
| 1,3-Butanediol | 15.0 parts |
| (water-soluble organic solvent) | |
| Triethanolamine | 3.0 parts |
| (pH controlling agent) | |
| Pure water | 59.0 parts |

### Example 2

The procedure for preparation of the black ink in Example 1 was repeated except that the black pigment dispersion A was replaced with the cyan pigment dispersion A, the black pigment dispersion D was replaced with the cyan pigment dispersion D, and the added amounts of glycerin and 1,3-butanediol were changed to 10.0 parts and 20.0 parts, respectively, to prepare a cyan ink.

### Example 3

The procedure for preparation of the black ink in Example 1 was repeated except that the black pigment dispersion A was replaced with the magenta pigment dispersion A, the black pigment dispersion D was replaced with the magenta pigment dispersion D, and the added amounts of glycerin and 1,3-butanediol were changed to 10.0 parts and 20.0 parts, respectively, to prepare a magenta ink.

### Example 4

The procedure for preparation of the black ink in Example 1 was repeated except that the black pigment dispersion A was replaced with the yellow pigment dispersion A, the black pigment dispersion D was replaced with the yellow pigment dispersion D, and the added amounts of glycerin and 1,3-butanediol were changed to 10.0 parts and 20.0 parts, respectively, to prepare a yellow ink.

### Example 5

The procedure for preparation of the black ink in Example 1 was repeated except that the formula of the ink was changed as follows to prepare a black ink.

| | |
|---|---|
| Black pigment dispersion A | 5.0 parts |
| (resin-covered pigment dispersion) | |
| Black pigment dispersion D | 3.0 parts |
| (surfactant-treated pigment dispersion) | |
| Glycerin | 15.0 parts |
| (water-soluble organic solvent) | |
| 2,2,4-Trimethyl-1,3-pentanediol | 15.0 parts |
| (water-soluble organic solvent) | |
| 10% Aqueous solution of potassium hydroxide | 2.5 parts |
| (pH controlling agent) | |
| Pure water | 59.5 parts |

### Example 6

The procedure for preparation of the black ink in Example 5 was repeated except that the black pigment dispersion A was replaced with the cyan pigment dispersion A, the black pigment dispersion D was replaced with the cyan pigment dispersion D, and the added amounts of glycerin and 2,2,4-trimethyl-1,3-pentanediol were changed to 10.0 parts and 20.0 parts, respectively, to prepare a cyan ink.

### Example 7

The procedure for preparation of the black ink in Example 5 was repeated except that the black pigment dispersion A was replaced with the magenta pigment dispersion A, the black pigment dispersion D was replaced with the magenta pigment dispersion D, and the added amounts of glycerin and 2,2,4-trimethyl-1,3-pentanediol were changed to 10.0 parts and 20.0 parts, respectively, to prepare a magenta ink.

### Example 8

The procedure for preparation of the black ink in Example 5 was repeated except that the black pigment dispersion A was replaced with the yellow pigment dispersion A, the black pigment dispersion D was replaced with the yellow pigment dispersion D, and the added amounts of glycerin and 2,2,4-trimethyl-1,3-pentanediol were changed to 10.0 parts and 20.0 parts, respectively, to prepare a yellow ink.

### Example 9

The procedure for preparation of the black ink in Example 1 was repeated except that the formula of the ink was changed as follows to prepare a black ink.

| | |
|---|---|
| Black pigment dispersion B | 3.5 parts |
| (resin-covered pigment dispersion) | |
| Black pigment dispersion E | 4.5 parts |
| (surfactant-treated pigment dispersion) | |
| Glycerin | 15.0 parts |
| (water-soluble organic solvent) | |
| 1,3-Butanediol | 15.0 parts |
| (water-soluble organic solvent) | |
| Tetrabutylammonium hydroxide | 3.5 parts |
| (pH controlling agent) | |
| Pure water | 58.5 parts |

### Example 10

The procedure for preparation of the black ink in Example 9 was repeated except that the black pigment dispersion B was replaced with the cyan pigment dispersion B, the black pigment dispersion E was replaced with the cyan pigment dispersion E, and the added amounts of glycerin and 1,3-butanediol were changed to 10.0 parts and 20.0 parts, respectively, to prepare a cyan ink.

### Example 11

The procedure for preparation of the black ink in Example 9 was repeated except that the black pigment dispersion B was replaced with the magenta pigment dispersion B, the black pigment dispersion E was replaced with the magenta pigment dispersion E, and the added amounts of glycerin and 1,3-butanediol were changed to 10.0 parts and 20.0 parts, respectively, to prepare a magenta ink.

### Example 12

The procedure for preparation of the black ink in Example 9 was repeated except that the black pigment dispersion B was replaced with the yellow pigment dispersion B, the black pigment dispersion E was replaced with the yellow pigment dispersion E, and the added amounts of glycerin and 1,3-butanediol were changed to 10.0 parts and 20.0 parts, respectively, to prepare a yellow ink.

### Example 13

The procedure for preparation of the black ink in Example 1 was repeated except that the formula of the ink was changed as follows to prepare a black ink.

| | |
|---|---|
| Black pigment dispersion A | 3.0 parts |
| (resin-covered pigment dispersion) | |
| Black pigment dispersion F | 5.0 parts |
| (surfactant-treated pigment dispersion) | |
| 1,3-Butanediol | 15.0 parts |
| (water-soluble organic solvent) | |
| 2,2,4-Trimethyl-1,3-pentanediol | 15.0 parts |
| (water-soluble organic solvent) | |
| Triethanolamine | 3.0 parts |
| (pH controlling agent) | |
| Pure water | 59.0 parts |

### Example 14

The procedure for preparation of the black ink in Example 13 was repeated except that the black pigment dispersion A was replaced with the cyan pigment dispersion A, the black pigment dispersion F was replaced with the cyan pigment dispersion F, and the added amounts of 1,3-butanediol and 2,2,4-trimethyl-1,3-pentanediol were changed to 10.0 parts and 20.0 parts, respectively, to prepare a cyan ink.

### Example 15

The procedure for preparation of the black ink in Example 13 was repeated except that the black pigment dispersion A was replaced with the magenta pigment dispersion A, the black pigment dispersion F was replaced with the magenta pigment dispersion F, and the added amounts of 1,3-butanediol and 2,2,4-trimethyl-1,3-pentanediol were changed to 10.0 parts and 20.0 parts, respectively, to prepare a magenta ink.

### Example 16

The procedure for preparation of the black ink in Example 13 was repeated except that the black pigment dispersion A was replaced with the yellow pigment dispersion A, the black pigment dispersion F was replaced with the yellow pigment dispersion F, and the added amounts of 1,3-butanediol and 2,2,4-trimethyl-1,3-pentanediol were changed to 10.0 parts and 20.0 parts, respectively, to prepare a yellow ink.

### Comparative Example 1

The procedure for preparation of the black ink in Example 1 was repeated except that the formula of the ink was changed as follows to prepare a black ink.

| | |
|---|---|
| Black pigment dispersion A | 8.0 parts |
| (resin-covered pigment dispersion) | |
| Glycerin | 15.0 parts |
| (water-soluble organic solvent) | |
| 1,3-Butanediol | 15.0 parts |
| (water-soluble organic solvent) | |
| Triethanolamine | 3.0 parts |
| (pH controlling agent) | |
| Pure water | 59.0 parts |

### Comparative Example 2

The procedure for preparation of the black ink in Comparative Example 1 was repeated except that the black pigment dispersion A was replaced with the cyan pigment dispersion A, and the added amounts of glycerin and 1,3-butanediol were changed to 10.0 parts and 20.0 parts, respectively, to prepare a cyan ink.

### Comparative Example 3

The procedure for preparation of the black ink in Comparative Example 1 was repeated except that the black pigment dispersion A was replaced with the magenta pigment dispersion A, and the added amounts of glycerin and 1,3-butanediol were changed to 10.0 parts and 20.0 parts, respectively, to prepare a magenta ink.

### Comparative Example 4

The procedure for preparation of the black ink in Comparative Example 1 was repeated except that the black pigment dispersion A was replaced with the yellow pigment dispersion A, and the added amounts of glycerin and 1,3-butanediol were changed to 10.0 parts and 20.0 parts, respectively, to prepare a yellow ink.

### Comparative Example 5

The procedure for preparation of the black ink in Example 1 was repeated except that the formula of the ink was changed as follows to prepare a black ink.

| | |
|---|---|
| Black pigment dispersion D | 8.0 parts |
| (surfactant-treated pigment dispersion) | |
| Glycerin | 15.0 parts |
| (water-soluble organic solvent) | |
| 2,2,4-Trimethyl-1,3-pentanediol | 15.0 parts |
| (water-soluble organic solvent) | |
| Triethanolamine | 3.0 parts |
| (pH controlling agent) | |
| Pure water | 59.0 parts |

### Comparative Example 6

The procedure for preparation of the black ink in Comparative Example 5 was repeated except that the black pigment dispersion D was replaced with the cyan pigment dispersion D, and the added amounts of glycerin and 2,2,4-trimethyl-1,3-pentanediol were changed to 10.0 parts and 20.0 parts, respectively, to prepare a cyan ink.

### Comparative Example 7

The procedure for preparation of the black ink in Comparative Example 5 was repeated except that the black pigment dispersion D was replaced with the magenta pigment dispersion D, and the added amounts of glycerin and 2,2,4-trimethyl-1,3-pentanediol were changed to 10.0 parts and 20.0 parts, respectively, to prepare a magenta ink.

### Comparative Example 8

The procedure for preparation of the black ink in Comparative Example 5 was repeated except that the black pigment dispersion D was replaced with the yellow pigment dispersion D, and the added amounts of glycerin and 2,2,4-trimethyl-1,3-pentanediol were changed to 10.0 parts and 20.0 parts, respectively, to prepare a yellow ink.

### Comparative Example 9

The procedure for preparation of the black ink in Example 1 was repeated except that the formula of the ink was changed as follows to prepare a black ink.

| | |
|---|---|
| Black pigment dispersion C | 3.0 parts |
| (resin-covered pigment dispersion) | |
| Black pigment dispersion D | 5.0 parts |
| (surfactant-treated pigment dispersion) | |
| Glycerin | 10.0 parts |
| (water-soluble organic solvent) | |
| 1,3-Butanediol | 20.0 parts |
| (water-soluble organic solvent) | |
| Triethanolamine | 3.0 parts |
| (pH controlling agent) | |
| Pure water | 59.0 parts |

### Comparative Example 10

The procedure for preparation of the black ink in Comparative Example 9 was repeated except that the black pigment dispersion C was replaced with the cyan pigment dispersion C, and the black pigment dispersion D was replaced with the cyan pigment dispersion D to prepare a cyan ink.

### Comparative Example 11

The procedure for preparation of the black ink in Comparative Example 9 was repeated except that the black pigment dispersion C was replaced with the magenta pigment dispersion C, and the black pigment dispersion D was replaced with the magenta pigment dispersion D to prepare a magenta ink.

### Comparative Example 12

The procedure for preparation of the black ink in Comparative Example 9 was repeated except that the black pigment dispersion C was replaced with the yellow pigment dispersion C, and the black pigment dispersion D was replaced with the yellow pigment dispersion D to prepare a yellow ink.

### Comparative Example 13

The procedure for preparation of the black ink in Example 1 was repeated except that the formula of the ink was changed as follows to prepare a black ink.

| | |
|---|---|
| Black pigment dispersion A | 3.5 parts |
| (resin-covered pigment dispersion) | |
| Black pigment dispersion G | 4.0 parts |
| (surfactant-treated pigment dispersion) | |
| Glycerin | 10.0 parts |
| (water-soluble organic solvent) | |
| 1,3-Butanediol | 20.0 parts |
| (water-soluble organic solvent) | |
| Tetrabutylammonium hydroxide | 3.0 parts |
| (pH controlling agent) | |
| Pure water | 59.5 parts |

### Comparative Example 14

The procedure for preparation of the black ink in Comparative Example 13 was repeated except that the black pigment dispersion A was replaced with the cyan pigment dispersion A, and the black pigment dispersion G was replaced with the cyan pigment dispersion G to prepare a cyan ink.

### Comparative Example 15

The procedure for preparation of the black ink in Comparative Example 13 was repeated except that the black pigment dispersion A was replaced with the magenta pigment dispersion A, and the black pigment dispersion G was replaced with the magenta pigment dispersion G to prepare a magenta ink.

### Comparative Example 16

The procedure for preparation of the black ink in Comparative Example 13 was repeated except that the black pigment dispersion A was replaced with the yellow pigment dispersion A, and the black pigment dispersion G was replaced with the yellow pigment dispersion G to prepare a yellow ink.

### Comparative Example 17

The procedure for preparation of the black ink in Example 1 was repeated except that the added amount of triethanolamine serving as a pH controlling agent was changed from 3.0 parts to 1.0 part, and the added amount of pure water was changed from 59.0 parts to 61.0 parts to prepare a black ink.

### Comparative Example 18

The procedure for preparation of the black ink in Comparative Example 17 was repeated except that the black pigment dispersion A was replaced with the cyan pigment dispersion A, the black pigment dispersion D was replaced with the cyan pigment dispersion D, and the added amounts of glycerin and 1,3-butanediol were changed to 10.0 parts and 20.0 parts, respectively, to prepare a cyan ink.

### Comparative Example 19

The procedure for preparation of the black ink in Comparative Example 17 was repeated except that the black pigment dispersion A was replaced with the magenta pigment dispersion A, the black pigment dispersion D was replaced with the magenta pigment dispersion D, and the added amounts of glycerin and 1,3-butanediol were changed to 10.0 parts and 20.0 parts, respectively, to prepare a magenta ink.

### Comparative Example 20

The procedure for preparation of the black ink in Comparative Example 17 was repeated except that the black pigment dispersion A was replaced with the yellow pigment dispersion A, the black pigment dispersion D was replaced with the yellow pigment dispersion D, and the added amounts of glycerin and 1,3-butanediol were changed to 10.0 parts and 20.0 parts, respectively, to prepare a yellow ink.

### Comparative Example 21

The procedure for preparation of the black ink in Example 1 was repeated except that the added amount of triethanolamine serving as a pH controlling agent was changed from 3.0 parts to 5.0 parts, and the added amount of pure water was changed from 59.0 parts to 57.0 parts to prepare a black ink.

### Comparative Example 22

The procedure for preparation of the black ink in Comparative Example 21 was repeated except that the black pigment dispersion A was replaced with the cyan pigment dispersion A, the black pigment dispersion D was replaced with the cyan pigment dispersion D, and the added amounts of glycerin and 1,3-butanediol were changed to 10.0 parts and 20.0 parts, respectively, to prepare a cyan ink.

### Comparative Example 23

The procedure for preparation of the black ink in Comparative Example 21 was repeated except that the black pigment dispersion A was replaced with the magenta pigment dispersion A, the black pigment dispersion D was replaced with the magenta pigment dispersion D, and the added amounts of glycerin and 1,3-butanediol were changed to 10.0 parts and 20.0 parts, respectively, to prepare a magenta ink.

### Comparative Example 24

The procedure for preparation of the black ink in Comparative Example 21 was repeated except that the black pigment dispersion A was replaced with the yellow pigment dispersion A, the black pigment dispersion D was replaced with the yellow pigment dispersion D, and the added amounts of glycerin and 1,3-butanediol were changed to 10.0 parts and 20.0 parts, respectively, to prepare a yellow ink.

Each of the inks prepared above was evaluated with respect to the following properties.

### 1. Preservation Stability

Each ink was contained in an ink cartridge, and the ink cartridge was allowed to settle for 3 weeks in a chamber heated to 65° C. After the preservation test, the cartridge was observed to determine whether the viscosity of the ink increases and the ink is agglomerated. The preservation stability of the ink was graded as follows.

⊚: The viscosity of the ink does not increase, and the ink is not agglomerated. (Excellent)
∘: The ink is slightly agglomerated. (Acceptable)
Δ: The viscosity of the ink clearly increases, and the ink is clearly agglomerated.

### (Unacceptable)

X: The viscosity of the ink seriously increases, and the ink is seriously agglomerated. (Bad)

### 2. Ejection Stability

Each ink was contained in a cartridge, and the cartridge was set in an inkjet printer (IPSIO GX5000 from Ricoh Co., Ltd.). The time period from start of an image forming operation, which was repeatedly performed without performing capping and cleaning on the recording head, to the time at which one of the following problems (1) and (2) was caused was measured.

(1) The flying direction of ejected ink droplets changed; and
(2) The weight of ejected ink droplets changed.

The ejection stability of the ink was graded as follows.

⊚: The time period is not shorter than 600 seconds. (Excellent)
∘: The time period is not shorter than 120 seconds and shorter than 600 seconds. (Acceptable)
Δ: The time period is not shorter than 30 seconds and shorter than 120 seconds. (Unacceptable)
X: The time period is shorter than 30 seconds. (Bad)

### 3. Abrasion Resistance of Ink Image

Each ink was contained in a cartridge, and the cartridge was set in an inkjet printer (IPSIO GX5000 from Ricoh Co., Ltd.). An ink image was recorded at a resolution of 600 dpi on a sheet of a recording paper (TYPE 6200 from Ricoh Business Expert, Ltd.). After the ink image was naturally dried, the ink image was abraded with a cotton cloth ten times, and the surface of the cotton cloth was visually observed to determine whether the ink is transferred to the cotton cloth. The abrasion resistance of the ink was graded as follows.

⊚: The pigment of the ink is not transferred to the cotton cloth. (Excellent)
∘: The pigment of the ink is slightly transferred to the cotton cloth. (Acceptable)
Δ: The pigment of the ink is clearly transferred to the cotton cloth. (Unacceptable)
X: The pigment of the ink is seriously transferred to the cotton cloth. (Bad)

### 4. Resistance to Marker Pen

After a portion of the ink image prepared in paragraph 3 was colored with a marker pen (PROPUS 2 from Mitsubishi Pencil Co., Ltd.), the colored portion was visually observed to determined whether the ink image is damaged. The resistance of the ink to the marker pen was graded as follows.

⊚: The pigment of the ink is not released from the ink image, and the colored portion is not contaminated with the ink. (Excellent)
∘: The pigment of the ink is slightly released from the ink image, and the colored portion is slightly contaminated with the ink. (Acceptable)
Δ: The pigment of the ink is clearly released from the ink image, and the colored portion is clearly contaminated with the ink. (Unacceptable)
X: The pigment of the ink is seriously released from the ink image, and the colored portion is seriously contaminated with the ink. (Bad)

### 5. Image Density

Each ink was contained in a cartridge, and the cartridge was set in an inkjet printer (IPSIO GX5000 from Ricoh Co., Ltd.). A solid image was recorded on a sheet of a recording paper (TYPE 6200 from Ricoh Business Expert, Ltd.) under an environmental condition of 25° C. and 50% RH. The image density of the solid image was measured with a densitometer X-RITE 938 from X-Rite Inc. The image density property of the ink was graded as follows.

⊚: The image density is not lower than 1.0. (Excellent)
∘: The image density is not lower than 0.8 and lower than 1.0. (Acceptable)
Δ: The image density is not lower than 0.6 and lower than 0.8. (Unacceptable)
X: The image density is lower than 0.6. (Bad)

The evaluation results are shown in Table 1 below.

TABLE 1

| | | | | Resistance | Resistance | |
|---|---|---|---|---|---|---|
| | pH of | Preservation | Ejection | to | to marker | Image |
| | ink | stability | stability | abrasion | pen | density |
| Ex. 1 | 9.1 | ⊚ | ⊚ | ⊚ | ⊚ | ⊚ |
| Ex. 2 | 8.7 | ⊚ | ⊚ | ⊚ | ⊚ | ⊚ |
| Ex. 3 | 9.8 | ⊚ | ⊚ | ⊚ | ⊚ | ⊚ |
| Ex. 4 | 10.0 | ⊚ | ⊚ | ⊚ | ⊚ | ⊚ |
| Ex. 5 | 8.6 | ◯ | ◯ | ⊚ | ⊚ | ⊚ |
| Ex. 6 | 9.6 | ◯ | ◯ | ⊚ | ⊚ | ⊚ |
| Ex. 7 | 9.3 | ◯ | ◯ | ⊚ | ⊚ | ⊚ |
| Ex. 8 | 10.1 | ◯ | ◯ | ⊚ | ⊚ | ⊚ |
| Ex. 9 | 8.9 | ◯ | ⊚ | ◯ | ◯ | ⊚ |
| Ex. 10 | 10.2 | ◯ | ⊚ | ◯ | ◯ | ⊚ |
| Ex. 11 | 9.9 | ◯ | ⊚ | ◯ | ◯ | ⊚ |
| Ex. 12 | 9.6 | ◯ | ⊚ | ◯ | ◯ | ⊚ |
| Ex. 13 | 9.0 | ◯ | ◯ | ⊚ | ⊚ | ⊚ |
| Ex. 14 | 8.6 | ◯ | ◯ | ⊚ | ⊚ | ⊚ |
| Ex. 15 | 9.7 | ◯ | ◯ | ⊚ | ⊚ | ⊚ |
| Ex. 16 | 9.9 | ◯ | ◯ | ⊚ | ⊚ | ⊚ |
| Comp. | 9.3 | Δ | Δ | ⊚ | ⊚ | ◯ |
| Ex. 1 | | | | | | |
| Comp. | 9.0 | Δ | Δ | ⊚ | ⊚ | ◯ |
| Ex. 2 | | | | | | |
| Comp. | 10.1 | Δ | Δ | ⊚ | ⊚ | ◯ |
| Ex. 3 | | | | | | |
| Comp. | 10.3 | Δ | Δ | ⊚ | ⊚ | ◯ |
| Ex. 4 | | | | | | |
| Comp. | 9.1 | ◯ | ⊚ | X | X | ⊚ |
| Ex. 5 | | | | | | |
| Comp. | 8.8 | ◯ | ⊚ | X | X | ⊚ |
| Ex. 6 | | | | | | |
| Comp. | 9.5 | ◯ | ⊚ | X | X | ⊚ |
| Ex. 7 | | | | | | |
| Comp. | 10.0 | ◯ | ⊚ | X | X | ⊚ |
| Ex. 8 | | | | | | |
| Comp. | 10.4 | X | Δ | ◯ | ⊚ | ◯ |
| Ex. 9 | | | | | | |
| Comp. | 9.5 | X | Δ | ◯ | ⊚ | ◯ |
| Ex. 10 | | | | | | |
| Comp. | 10.2 | X | Δ | ◯ | ⊚ | ◯ |
| Ex. 11 | | | | | | |
| Comp. | 9.9 | X | Δ | ◯ | ⊚ | ◯ |
| Ex. 12 | | | | | | |
| Comp. | 8.9 | X | Δ | ⊚ | ◯ | ⊚ |
| Ex. 13 | | | | | | |
| Comp. | 8.9 | X | Δ | ⊚ | ◯ | ⊚ |
| Ex. 14 | | | | | | |
| Comp. | 9.1 | X | Δ | ⊚ | ◯ | ⊚ |
| Ex. 15 | | | | | | |
| Comp. | 9.2 | X | Δ | ⊚ | ◯ | ⊚ |
| Ex. 16 | | | | | | |
| Comp. | 8.1 | X | Δ | ⊚ | ⊚ | ⊚ |
| Ex. 17 | | | | | | |
| Comp. | 7.8 | X | Δ | ⊚ | ⊚ | ⊚ |
| Ex. 18 | | | | | | |
| Comp. | 8.0 | X | Δ | ⊚ | ⊚ | ⊚ |
| Ex. 19 | | | | | | |
| Comp. | 7.9 | X | Δ | ⊚ | ⊚ | ⊚ |
| Ex. 20 | | | | | | |
| Comp. | 10.8 | X | X | ⊚ | ⊚ | ⊚ |
| Ex. 21 | | | | | | |
| Comp. | 11.2 | X | X | ⊚ | ⊚ | ⊚ |
| Ex. 22 | | | | | | |
| Comp. | 10.9 | X | X | ⊚ | ⊚ | ⊚ |
| Ex. 23 | | | | | | |
| Comp. | 11.5 | X | X | ⊚ | ⊚ | ⊚ |
| Ex. 24 | | | | | | |

It is clear from Table 1 that the inks of Examples 1-4 are excellent with respect to the above-mentioned properties. The inks of Examples 5-8 are excellent or good (acceptable) with respect to the above-mentioned properties, but are slightly inferior to the inks of Examples 1-4 with respect to ejection stability because the content of the resin-covered pigment is higher than that of the surfactant-treated pigment. In addition, the inks of Examples 5-8 are slightly inferior to the inks of Examples 1-4 with respect to the preservation stability because an alkali metal hydroxide is used as the pH controlling agent.

The inks of Examples 9-12, which includes a pigment covered with a resin which is not an acrylic polymer, a pigment treated with a nonionic surfactant which do not have formula (I) but includes a polyoxyethylene group as a hydrophilic group, and a quaternary ammonium hydroxide as a pH controlling agent, are excellent or good (acceptable) with respect to the above-mentioned properties, but are slightly inferior to the inks of Examples 1-4 with respect to preservation stability and resistance to abrasion and marker pen.

The inks of Examples 13-16, which includes a pigment treated with a nonionic surfactant which has no polyoxyethylene group as a hydrophilic group, are slightly inferior to the inks of Examples 1-4 with respect to preservation stability because the surfactant-treated pigment is slightly inferior to a pigment treated with a nonionic surfactant having a polyoxyethylene group with respect to the dispersibility.

In contrast, the inks of Comparative Examples 1-4, which do not include a surfactant-treated pigment and include only a resin-covered pigment prepared by an acid deposition method at a high concentration, have poor preservation stability.

The inks of Comparative Examples 5-8, which do not include a resin-covered pigment and include only a nonionic-surfactant treated pigment at a high concentration, have poor resistance to abrasion and marker pen because the resistance improving effects of the resin-covered pigment cannot be produced.

The inks of Comparative Examples 9-12, which include a resin-covered pigment prepared by a phase transfer emulsification method and a nonionic surfactant-treated pigment, have poor preservation stability because the compatibility of the pigments is bad.

The inks of Comparative Examples 13-16, which include a resin-covered pigment prepared by an acid deposition method and an anionic surfactant-treated pigment, have poor preservation stability because the resin covering the pigment is seriously released therefrom.

The inks of Comparative Examples 17-20, which have a pH lower than 8.5 because of including the pH controlling agent in a smaller amount than the inks of Examples 1-4, have poor preservation stability because the resin covering the resin-covered pigment is hardly released therefrom, thereby deteriorating dispersion stability of the surfactant-treated pigment in the ink.

The inks of Comparative Examples 21-24, which have a pH higher than 10.5 because of including the pH controlling agent in a lager amount than the inks of Examples 1-4, have poor preservation stability because the resin covering the resin-covered pigment is seriously released therefrom, thereby deteriorating the preservation stability of the inks. In addition, the inks have poor ejection stability because of having a higher viscosity due to the resin released from the resin-covered pigment.

Additional modifications and variations of this disclosure are possible in light of the above teachings. It is therefore to be understood that within the scope of the appended claims the invention may be practiced other than as specifically described herein.

What is claimed is:

1. An inkjet ink comprising:
an aqueous medium including:
water; and
a water-soluble organic solvent;
a resin-covered pigment dispersed in the aqueous medium, wherein the resin-covered pigment is prepared by an acid deposition method; and
a surfactant-treated pigment dispersed in the aqueous medium, wherein the surfactant-treated pigment is prepared by treating a pigment with a nonionic surfactant,
wherein the inkjet ink has a pH in a range of from 8.5 to 10.5.

2. The inkjet ink according to claim 1, wherein the resin-covered pigment (A) and the surfactant-treated pigment (B) are included in the inkjet ink in a weight ratio (A/B) of from 50/50 to 1/90.

3. The inkjet ink according to claim 1, wherein the resin of the resin-covered pigment includes at least a unit obtained from an acrylic monomer having a carboxyl group.

4. The inkjet ink according to claim 1, wherein the nonionic surfactant of the surfactant-treated pigment includes a polyoxyethylene group as a hydrophilic group.

5. The inkjet ink according to claim 1, wherein the surfactant of the nonionic surfactant-treated pigment has the following formula (I): 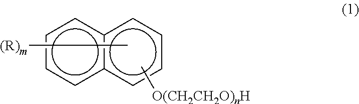
wherein R represents an alkyl group having 1 to 20 carbon atoms, an aryl group, or an aralkyl group, m is 0 or an integer of from 1 to 7, and n is an integer of from 20 to 200.

6. An ink cartridge comprising:
a container; and
the inkjet ink according to claim 1, which is contained in the container.

7. An inkjet recording apparatus comprising:
6. cartridge according to claim 6; and
a recording head to eject droplets of the inkjet ink contained in the container of the ink cartridge to form an image on a recording material.

8. An inkjet recording method comprising:
ejecting the inkjet ink according to claim 1 by applying a stimulus thereto to form an image on a recording material.

9. A print comprising:
a support; and
an ink image formed on the support using the inkjet ink according to claim 1.
